(19) United States
(12) Patent Application Publication
(10) Pub. No.: US 2002/0081088 A1
(43) Pub. Date: Jun. 27, 2002

(54) Housing for packaging optical device, method for receiving optical device, and optical device

(76) Inventor: Hiroshi Kasai, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 09/962,462

(22) Filed: Sep. 26, 2001

(30) Foreign Application Priority Data
Dec. 25, 2000 (JP) JP2000-392727

(51) Int. Cl. G02B 6/00

(52) U.S. Cl. 385/135; 385/134

(57) ABSTRACT

In order to flexibly respond to the change of the position for taking out an optical fiber from the housing for an optical device, there are provided a rotatable fiber fixing tool 13 for fixing an I/O fiber 10, which is fitted to a rectangular intersecting portion A located on the straight extension line of an optical fiber receiving portion 7, and a fiber take-out opening 14 enabling the I/O fiber fixed to the fiber fixing tool 13 to be taken out in the desired direction.

### BACKGROUND OF THE INVENTION

1. Field of the Invention

The present invention relates to the packaging of an optical device as used in the optical communication system, and more particularly, to a housing for packaging the optical device, a method for receiving the optical device in the housing, and an optical device.

2. Description of Related Art

In general, the optical device is made up of optical parts and optical fibers which are received in and fixed to the housing, the optical fibers being further extended through the housing in order to receive/output the optical signal incoming to/outgoing from the optical device.

An example of the optical device will be explained by way of a conventional optical amplifier module as shown in FIG. 7 of the accompanying drawings.

The optical amplifier module is made up of a plurality of optical parts such as a light emitting element module 1, a light receiving element module 2, an optical isolator 3, and an optical branch coupler 4. Lead fibers (not shown) made of optical fibers taken out from respective optical parts are connected with predetermined portions by means of fusion welding or the like.

Respective optical parts are received in and fixed to their corresponding optical part fixing tools 5 while lead fibers are received in their corresponding optical fiber receiving portions 7 made up of fiber guides 6.

The optical part fixing tool 5, the fiber guide 6, and others are integrally formed with an optical part mounting board 8 forming a part of the housing, or separately prepared and then fixed thereto. The optical part mounting board 8 is fixed to a box-like case 9.

An input/output (abbreviated to ‘I/O’ hereinafter) fiber 10 is connected with the lead fiber taken out from the optical part, and is then fixed to the I/O fiber fixing tool 11, and is further extended to the outside of the housing passing through a notch formed in the case 9 constituting the housing.

The optical amplifier module is optically interfaced through an I/O connector 12 fitted to the I/O fiber 10.

The optical fiber receiving portion 7 formed between adjacent fiber guides has the function of guiding the optical fiber such that the optical fiber is not bent exceeding a bending radius R specified therefor (generally, R30 mm), and also the width of the optical fiber receiving portion 7 is determined such that the optical fiber can have a certain proper margin, in other words, the entire length when it is straightened, is longer than the actual path of the optical fiber receiving portion 7.

It is preferable for the optical fiber used in the optical amplifier module to have a possibly smaller diameter in order to save the space for receiving it. For this purpose, an ultraviolet curing resin coated strand fiber (referred to as merely ‘strand fiber’ hereinafter) having a diameter of 0.25 mm is often used for the lead fiber taken out from the optical part fitted to the housing. On one hand, a nylon coated core fiber (referred to as ‘core fiber’ hereinafter) having a diameter of 0.9 mm is also often used for the I/O fiber 10 in order to prevent the breakdown of the strand fiber which might be caused when mounting the optical amplifier module onto the optical communication system.

According to the conventional constitution as described above, however, the position of taking out the I/O fiber is fixed, so that this fixed I/O fiber take-out position becomes a problem as the case may be, for instance the packaging condition in the optical communication system, the positional relation with the optical interface and so forth.

In that case, the design with respect to each take-out position of the I/O fiber has to be changed. This would act as minus factors against the design efficiency and the manufacturing cost as well.

As described above, the core fiber is often used for the I/O fiber of the optical amplifier module. However, if the core fiber is connected with a corresponding portion or fiber by means of fusion welding, the core fiber up to its connected point has to be received in the housing. In that case, since the core fiber is relatively thicker, the space for receiving the fiber in the housing can not help being made larger. This is not suitable for miniaturizing the optical amplifier module.

Then, in order to realize the miniaturization, if the quantity of the core fiber winding received in the housing is reduced, various problems would come out. For instance, if the length of the optical fiber is shortened exceeding the margin thereof due to the failure of fusion welding, it becomes possible neither to receive the core fiber in the housing nor to ensure the tolerance of the fiber length to be taken out from the housing to the outside thereof.

### SUMMARY OF THE INVENTION

In order to solve the problems as described above, according to the invention, there is provided a rotatable fiber fixing tool for fixing the I/O fiber, the fiber fixing tool being fitted to a portion A (FIG. 1) where two extension lines of the straight parts (vertical and horizontal) of the optical fiber receiving porion intersect at right angle each other, thereby enabling the I/O fiber fixed to the fiber fixing tool to be taken out in the desirable directions. The above portion A will be referred to as ‘rectangular intersecting portion A’ hereinafter.

Furthermore, for miniaturization, the I/O fiber is made up of a strand fiber and a loose tube.

### DETAILED DESCRIPTION OF THE PREFERRED EMBODIMENTS

Certain preferred embodiments according to the invention relating to a housing for packaging the optical device, a method for receiving optical fibers, and an optical device will now be described in detail by way of examples and with reference to the accompanying drawings, wherein parts having like functions in each of the several figures are identified by the like reference numeral and character thereby omitting the redundant repetitive description thereabout. In the drawings:

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is a plane view of the first embodiment according to the invention.

FIG. 2 is a schematic illustration of a fiber fixing tool.

FIG. 3 shows the first example of an opening for taking out the optical fiber.

FIG. 4 shows the second example of an opening for taking out the optical fiber.

FIG. 5 is a plane view of the second embodiment according to the invention.

FIG. 6 is a plane view of the third embodiment according to the invention.

FIG. 7 is a plane view of a prior art optical amplifier module.

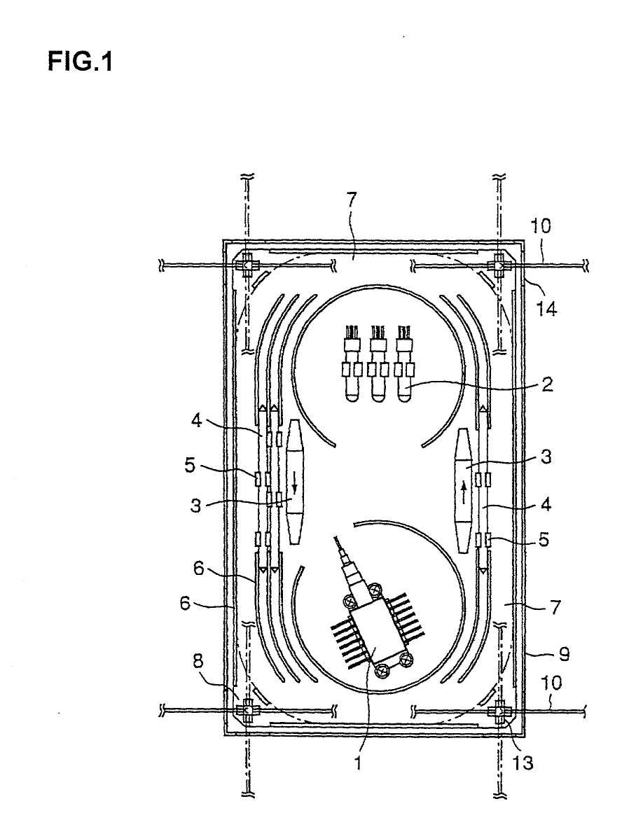

Referring to FIG. 1 showing a plane view of the first embodiment according to the invention, wherein an optical amplifier module is shown as an example of the optical device, and wherein, for the better and easy understanding of the following description, the same constituents of this optical amplifier module as those of the conventional optical amplifier module shown in FIG. 7 are identified by the same reference numeral and character. In this figure, a reference numeral 13 indicates a rotatable fiber fixing tool for fixing an I/O fiber 10 to the housing, the fiber fixing tool 13 being arranged at a rectangular intersecting portion A.

The optical fiber 10 is received in the housing in such a manner that it is bent at each inside corner portion of the housing to have a bending radius larger than the specified bending radius as described before. Therefore, each inside corner portion including the rectangular intersecting portion A comes to form a vacant space. Therefore, if a proper hole is bored in an optical part mounting board 8 such that it corresponds to the rectangular intersecting potion A, the fiber fixing tool 13 can be fitted to the above board 8 with the help of the hole.

The fiber fixing tool 13 may be made such that it can rotate by itself, or the fiber fixing tool 13 may be rotatively fitted to the optical part mounting board 8. In any event, however, it is needed that the fiber fixing tool 13 never causes any interference with the optical fiber received in the housing when it rotates.

The housing for use in the optical amplifier module has a rectangular shape in general, so that the number of rectangular intersecting portions A becomes four in total and all of them are available for fitting the fiber fixing tool 13 thereto.

In a case 9 constituting the housing, there are formed a plurality of fiber take-out openings or through holes 14 corresponding to four rectangular intersecting portions A to each of which the fiber fixing tool 13 is fitted, so that the I/O fiber 10 can be taken out through those fiber take-out openings or through holes 14 in a plurality of desired directions.

Accordingly, the I/O fiber 10 is taken out in the two different directions from each of four rectangular intersecting portions A, so that the I/O fiber 10 being taken out in the eight different directions in total.

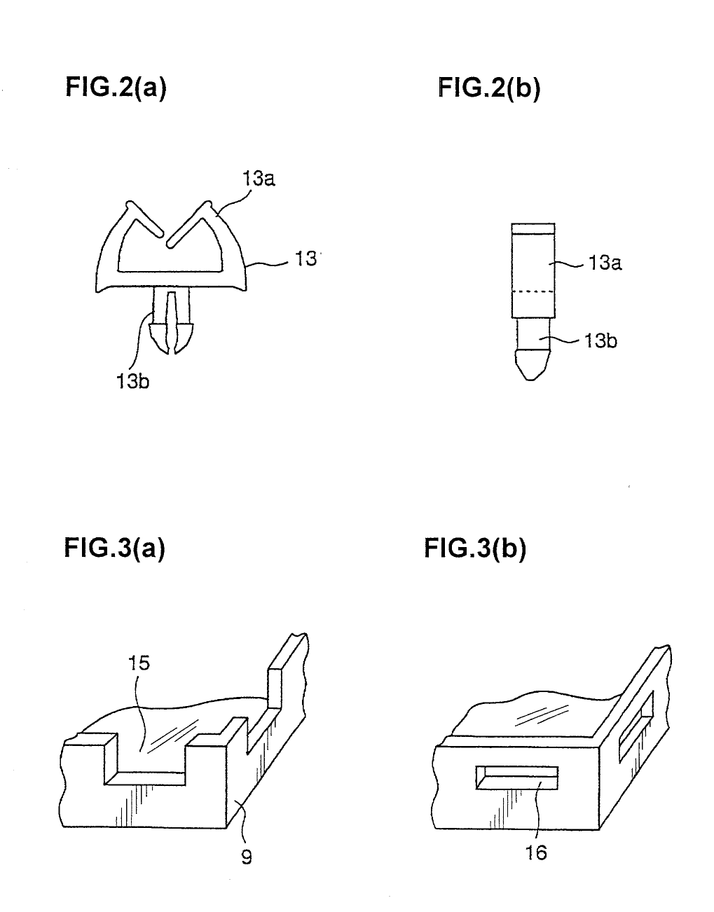

FIG. 2 shows schematic illustrations of a fiber fixing tool as is used in the first embodiment of the invention, wherein FIG. 2(a) is a plane view of the fiber fixing tool while FIG. 2(b) is a side view of the same.

The fiber fixing tool 13 is made of an elastic synthetic resin and includes a clamp portion 13a and a fitting portion 13b. The fiber fixing tool 13 is rotatively fitted to the optical part mounting board 8 as shown in FIG. 1 with ease by inserting the fitting portion 13b in the hole bored in the above board 8.

The I/O fiber 10 as shown in FIG. 1 is inserted in the clamp portion 13a and is fixed with an adhesive or the like.

The fiber fixing tool 13 has a small shape so that its rotation never causes any interference with the bent portion R of the optical fiber.

FIG. 3 is a schematic perspective view showing the first example of the fiber take-out opening provided in the case constituting the housing according to the first embodiment of the invention, wherein FIG. 3(a) shows the opening in the form of a notch while FIG. 3(b) shows the opening in the form of a hole.

FIG. 3(a) indicates that the fiber take-out opening 14 as shown in FIG. 1 is formed by providing notches 15 directing to two directions at the corner portion of the case 9.

FIG. 3(b) indicates that the fiber take-out opening 14 as shown in FIG. 1 is also formed by providing holes 16 in place of the notches 15.

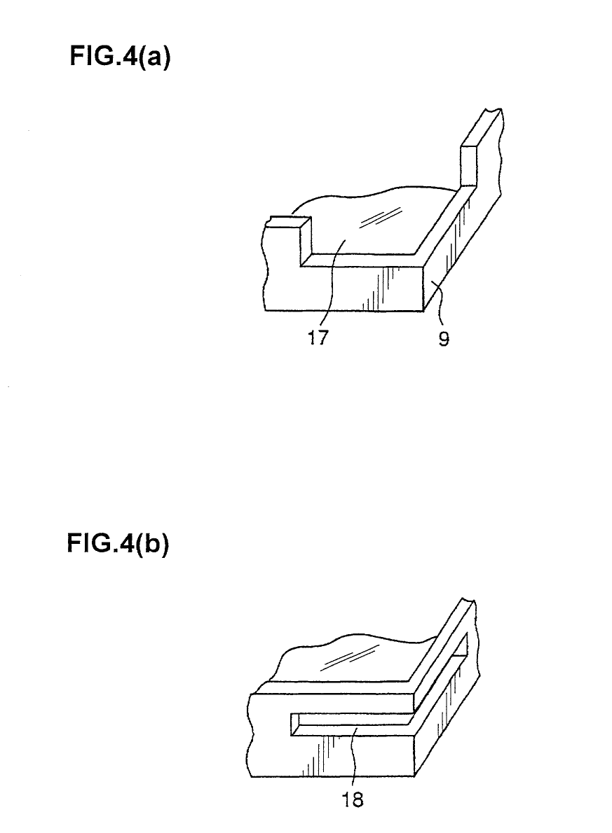

FIG. 4 is a schematic perspective view showing the second example of the fiber take-out opening provided in the case constituting the housing according to the first embodiment of the invention, wherein FIG. 4(a) shows the opening in the form of a notch while FIG. 4(b) shows the opening in the form of a hole.

FIG. 4(a) indicates that the fiber take-out opening 14 as shown in FIG. 1 is formed by providing a continuous notch 17 including two directions which is made by removing the corner of the case 9.

FIG. 4(b) indicates that the fiber take-out opening 14 as shown in FIG. 1 is formed by providing a continuous hole 18 including two directions in place of the notch 17.

The optical amplifier module is manufactured according to the following steps. To begin with, there is prepared a housing for packaging an optical device. Then, optical parts are received by and fixed to the housing while optical fibers are received by predetermined optical fiber receiving portions 7.

In the next, the fiber fixing tool 13 is fitted to a predetermined position i.e. the rectangular intersecting portion A from which the I/O fiber 10 is taken out. In this case, the fiber fixing tool 13 may be fitted to all of four rectangular intersecting portions A or to only a specified one.

Then, the fiber fixing tool 13 is rotated and the I/O fiber 10 is fixed in the direction to which the I/O fiber 10 is taken out.

The step of fixing the fiber fixing tool 13 to the optical part mounting board 8 may be carried out after the step of fixing the I/O fiber 10 to the fiber fixing tool 13.

In short, it is essential to take out the I/O fiber 10 in the predetermined direction by properly combining the order of the above manufacturing steps.

As has been discussed above, according to the first embodiment of the invention, the rotatable fiber fixing tool 13 is fitted to the rectangular intersecting portion A. With this, it becomes possible for the I/O fiber 10 to be taken out in different directions from different positions of the housing, and also it becomes possible to prevent the design efficiency and manufacturing cost from becoming worse even if the packaging condition is changed.

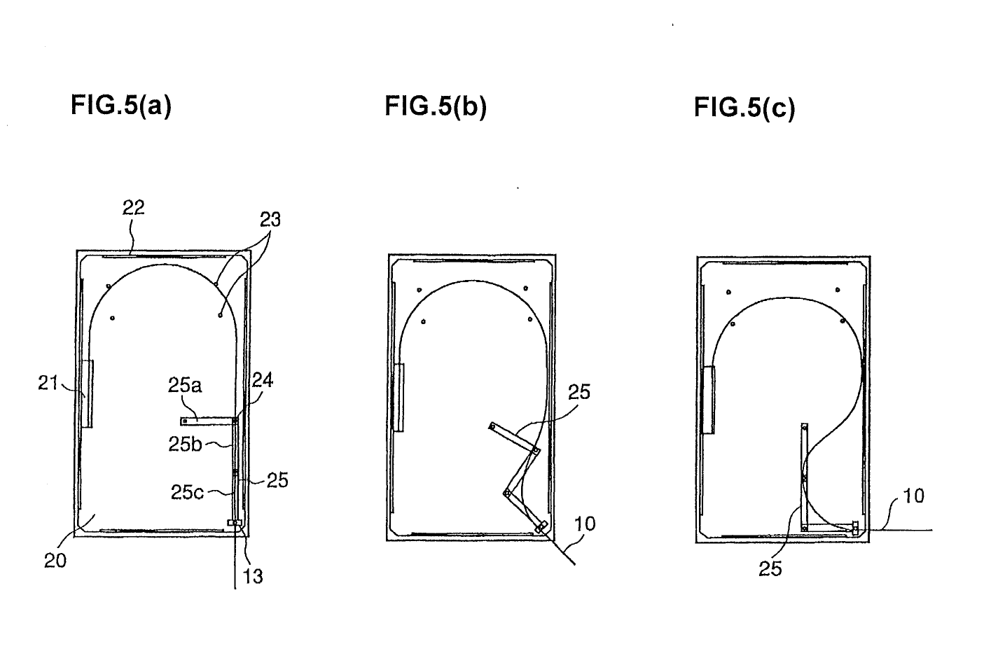

FIG. 5 is a plane view showing the second embodiment according to the invention, wherein FIG. 5(a), FIG. 5(b) and FIG. 5(c) indicate the cases that a crank mechanism 25 is not rotated, rotated by 45° and rotated by 90°, respectively.

The housing for packaging the optical device as shown in FIG. 5 is provided with a space which exclusively receives an I/O fiber 10 deformable with respect to the movement thereof, the space being formed with the help of an I/O fiber receiving board 20 located above the area for receiving optical parts and optical fibers as shown in FIG. 1.

The I/O fiber receiving board 20 is provided with a fiber take-out opening 21 for taking out the I/O fiber 10 from the area under the board 20, a fiber guide 22 and a fiber fixing tool 13.

The I/O fiber receiving board 20 is further provided with fiber guide projections 23 for guiding the I/O fiber 10 and a crank mechanism 25 which has a fiber holding tool 24 for holding the I/O fiber 10 and of which both ends are rotatively fixed.

The fiber holding tool 24 is formed in the shape of a ring for instance and the I/O fiber 10 is inserted therein to be held. This fiber holding tool 24 is fitted to the crank mechanism 25 to move following the movement of the I/O fiber 10.

The crank mechanism 25 is made up of three levers 25a, 25b and 25c, for instance. One end of the lever 25a and one end of the lever 25c are fitted to corresponding stationary rotative axes, respectively, while the other ends of them are fitted to moving rotative axes, respectively, together with both ends of the lever 25b.

In the second embodiment, the continuous notch 17 or hole 18 including two directions as shown in FIG. 4 is adapted as the fiber take-out opening.

In the second embodiment as constructed above, if the crank mechanism 25 is rotated from the non-rotated state as shown in FIG. 5(a) to the 45° rotated state of FIG. 5(b), the I/O fiber 10 is deformed in the space as above-mentioned. At this time, the crank mechanism 25 moves to the state as shown in the FIG. 5(b), holding the I/O fiber 10 by the fiber holding tool 24.

If the crank mechanism 25 is further rotated up to 90°, the I/O fiber 10 is deformed to take a shape of a letter S as shown in FIG. 5(c) while the crank mechanism 25 is deformed to take a shape of a letter L and gets in the stable state.

Accordingly, when the state of the I/O fiber 10 is changed from FIG. 5(a) to FIG. 5(c), 90° is added to the rotation angle of the I/O fiber 10, thus the degree of freedom in selecting the direction of taking out the I/O fiber 10 from the housing being increased.

Since the fiber guide projection 23 and the crank mechanism 25 are provided in order to ensure the bending radius of the I/O fiber 10, there is no need for both of them to be provided if the purpose is only to change the direction of the I/O fiber 10.

As discussed in the above, according to the second embodiment of the invention, in addition to the effect of the first embodiment, when packaging the optical amplifier module to the optical communication system, the direction of taking out the I/O fiber 10 can be determined by driving the crank mechanism 25 to deform the I/O fiber 10 as well as to rotate the fiber fixing tool 13.

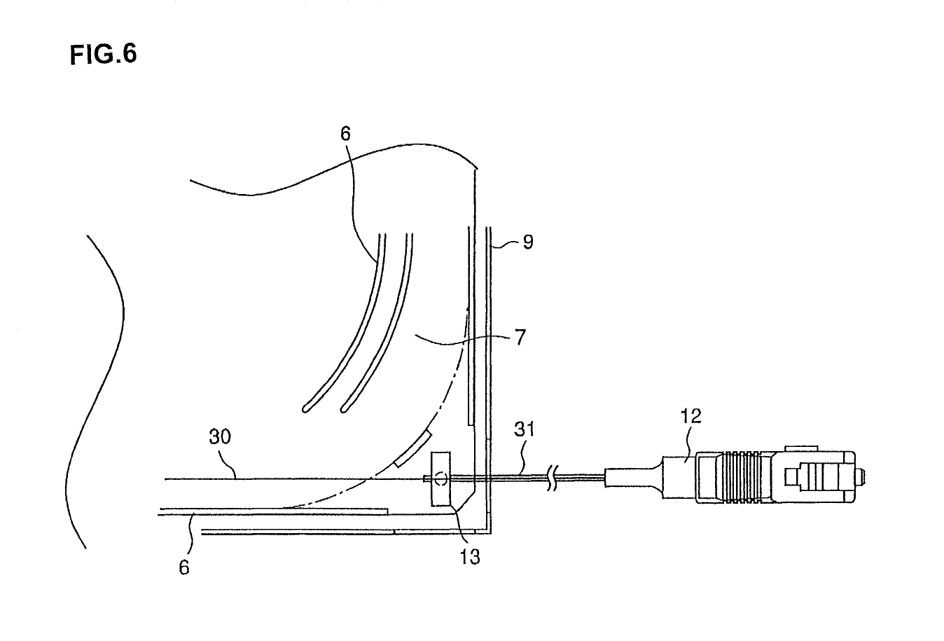

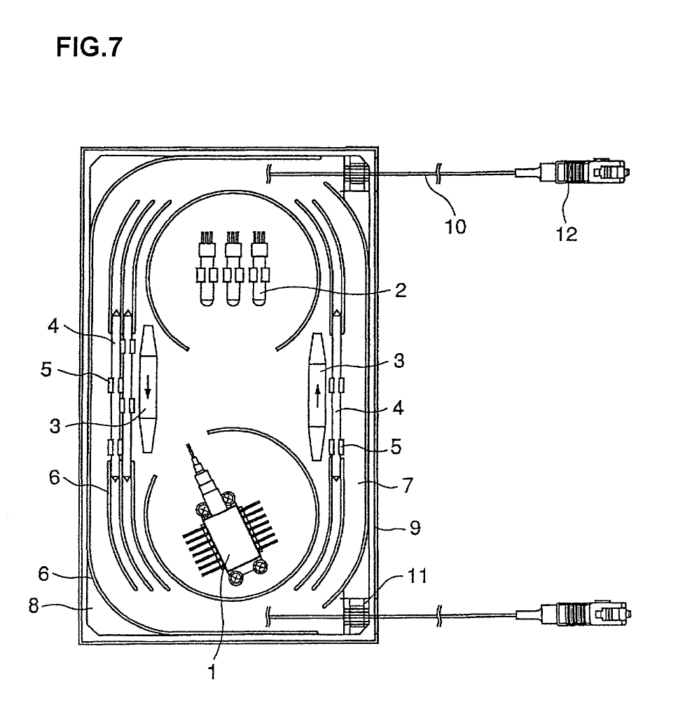

FIG. 6 is a plan view showing a principal part of the third embodiment according to the invention, wherein the take-out portion of the I/O fiber is illustrated.

In the third embodiment of the invention, the I/O fiber 10 as shown in FIG. 1 is made up of a strand fiber 30 and a loose tube 31 covering the strand fiber 30, in other words, made up of a strand fiber with a loose tube having a diameter 0.9 mm, for instance.

One end of the loose tube 31 is fixed to the I/O connector 12 together with the strand fiber 30 while the other end of the loose tube 31 is made free with respect to the strand fiber 30.

When fixing the I/O fiber to the housing for the optical amplifier module, only the end of the loose tube 31 is fixed to the fiber fixing tool 13 by an adhesive or the like.

The length of the loose tube 31 becomes equal to the sum of the length necessary for taking it out from the housing for the optical amplifier module and the length necessary for fixing it to necessary portions.

The strand fiber 30 is further extended long from the free end of the loose tube 31, so that being connected with a predetermined optical part, it is received in the fiber receiving portion 7 formed by the fiber guide 6 provided inside the housing for the optical amplifier module.

Furthermore, one end of the loose tube 31 is made free from the strand fiber 30, so that there is removed the problem on the slack of the strand fiber 30, which is caused by the difference in the thermal expansion coefficient between the loose tube 31 and the strand fiber 30 when they are fixed together at their both ends.

As described above, according to the third embodiment of the invention, the strand fiber 30 taken out from the housing for the optical amplifier module is protected by the loose tube 31, so that it can ensure the strength equivalent to that of the conventional core fiber. Furthermore, the fiber receiving portion 7 inside the housing may receive only the strand fiber 30 thinner than the core fiber, so that the fiber receiving portion can be made smaller without sacrificing any margin of the fiber length. With this, it becomes possible to miniaturize the optical amplifier module.

Furthermore, when the core fiber and the strand fiber coexist in the fiber receiving portion, both of them interfere with each other and the strand fiber comes to receive a certain stress. In the case like this, there is a possibility that the loss due to the light attenuation increases or the breakdown of the optical fiber takes place. However, since only the strand fiber is adapted, the interference as mentioned above is prevented absolutely.

The embodiments according to the invention has been described so far, by way of the optical amplifier module as an example of the optical device. However, the invention is not limited to the optical amplifier module but is applicable to all the optical devices having such a structure that the I/O optical fiber can be taken out from the housing of the device.

As has been explained above, certain preferred embodiments according to the invention relating to the housing for packaging the optical device, the method for receiving optical fibers, and the optical device have been described in detail by way of examples and with reference to the accompanying drawings. However, the invention is not limited to such examples. It is apparent that any one who has an ordinary skill in the art is able to make various changes and modifications within the technical thoughts as recited in the scope of claim for patent as per attached hereto, and it is understood that those changes and modifications belong to the technical scope of the invention, naturally.

As has been described above, according to the invention, it becomes possible to take out the I/O fiber from a desired position as well as in a desired direction by providing the rotatable fiber fixing tool in the rectangular intersecting portion A, thus making it possible to respond to the change of the packaging condition with ease, without worsening the design efficiency and the manufacturing cost as well.

What is claimed is:

1. A housing for packaging optical devices, capable of mounting optical parts and optical fibers, said housing comprising:
a plurality of through-holes for extend from inside to outside said optical fiber;
wherein said fiber capable of being taking out from any direction via one of said through-holes.

2. A housing for packaging optical devices as claimed in claim 1, wherein said housing has an almost rectangular shape, and said fiber fixing tool is arranged at a rectangular intersecting portion.

3. A housing for packaging optical devices as claimed in claim 1, further comprising a fiber fixing tool for rotatatively fixing said fiber to said housing.

4. A housing for packaging optical devices as claimed in claim 3, wherein said fiber fixing tool is arranged outside the bending space of the optical fiber.

5. A housing for packaging optical devices as claimed in claim 3, where in s aid fiber fixing tool is rotatable by itself.

6. A housing for packaging optical devices as claimed in claim 3, wherein said at least one pair of through holes are made up of two notches provided in two portions corresponding to the position of said fiber fixing tool so as to direct them to two directions.

7. A housing for packaging optical devices as claimed in claim 3, wherein at least one of said through holes is made up of a continuous notch provided in a portion corresponding to the position of said fiber fixing tool so as to include two directions.

8. A housing for packaging optical devices, which is capable of mounting optical parts and optical fibers, said housing comprising:
a optical fiber receiving portion for receiving optical fibers;
a plurality of through holes for extend from inside to outside said optical fiber;
a fiber fixing tool for rotatatively fixing said fiber to said housing; and
a fiber receiving board provided above a receiving area for receiving said optical parts and optical fiber, and forming a space in which the fiber can deform itself as it moves therein.

9. A housing for packaging optical devices as claimed in claim 8, wherein said at least one pair of through holes are made up of a continuous notch provided in a portion corresponding to the position of said fiber fixing tool so as to include two directions.

10. A housing for packaging optical devices as claimed in claim 8 further comprising a fiber guide for guiding said fiber in said space and a fiber holding tool for flexibly holding said fiber.

11. A housing for packaging optical devices as claimed in claim 10, wherein said fiber holding tool is constructed in the form of a crank mechanism.

12. A method for receiving an optical fiber comprising:
preparing a housing for packaging optical devices, which is capable of mounting optical parts and optical fibers and comprises an optical fiber receiving portion for receiving optical fibers, a plurality of through holes for extend taking from inside to outside said optical fiber, and a fiber fixing tool capable for rotatatively fixing said fiber to said housing;
receiving the optical fiber in said optical fiber receiving portion of said housing;
fitting said fiber fixing tool to a predetermined position;
rotating said fiber fixing tool so as to direct it to a predetermined direction; and
taking out said fiber in said predetermined direction by combining with said step of fixing said fiber to said fiber fixing tool.

13. A method for receiving an optical fiber comprising:
preparing a housing for packaging optical devices, which is capable of mounting optical parts and optical fibers and comprises an optical fiber receiving portion for receiving optical fibers, a plurality of through holes for extend from inside to outside said optical fiber, a fiber fixing tool for rotatatively fixing said fiber to said housing, and a fiber receiving board provided above a receiving area for receiving said optical parts and optical fiber and forming a space in which the fiber can deform itself as it moves therein;
receiving the optical fiber in said optical fiber receiving portion of said housing;
fixing the fiber to the fiber fixing tool located at a predetermined position;
rotating said fiber fixing tool by deforming said fiber when packaging the optical device to the optical communication system, thereby taking out said fiber in a predetermined direction.

14. An optical device of which the optical parts and optical fibers are received and fixed in the housing as claimed in claim 3, wherein the fiber is made up of a strand fiber and a loose tube covering said strand fiber.

15. An optical device as claimed in claim 14, wherein said loose tube is fixed to said fiber fixing tool only through its end portion.

16. An optical device as claimed in claim 15, wherein the length of said loose tube is made equal to the sum of the length of the loose tube taken out from said housing and the length of the same necessary for fixing it.

17. An optical device of which the optical parts and optical fibers are received and fixed in the housing as claimed in claim 7, wherein the fiber is made up of a strand fiber and a loose tube covering said strand fiber.

18. An optical device as claimed in claim 17, wherein said loose tube is fixed to said fiber fixing tool only through its end portion.

19. An optical device as claimed in claim 18, wherein the length of said loose tube is made equal to the sum of the length of the loose tube taken out from said housing and the length of the same necessary for fixing it.
